(19) United States
(12) Patent Application Publication
(10) Pub. No.: US 2025/0276425 A1
(43) Pub. Date: Sep. 4, 2025

(54) VISE HOLDING SYSTEM FOR PARALLELS AND/OR WORKPIECES

(71) Applicant: VARIABLE OPERATIONS TECHNOLOGIES, INC., CRYSTAL LAKE, IL (US)

(72) Inventors: Wojciech FURMAN, Crystal Lake, IL (US); Dominik P. BOGACZ, Crystal Lake, IL (US)

(73) Assignee: VARIABLE OPERATIONS TECHNOLOGIES, INC., CRYSTAL LAKE, IL (US)

(21) Appl. No.: 19/066,358

(22) Filed: Feb. 28, 2025

Related U.S. Application Data
(60) Provisional application No. 63/560,017, filed on Mar. 1, 2024.

(51) Int. Cl. B25B 1/24

(52) U.S. Cl. CPC B25B 1/2405

(57) ABSTRACT

Add-on components for a workpiece holder or vise, including a pair of jaws. A work piece lock element is moveable and lockable along a top surface of one of the pair of jaws. The work piece lock element can be or include a positive lock, such as including a threaded element, a rounded or spherical element, and/or a spring loaded ball. In embodiments, a row of detents is disposed in one of the jaws, and each of the detents is configured to receive the positive lock in one position. An adjustable side extension can be included for laterally securing workpieces in the holder. A pair of clips, each attached to a side of one of the pair of jaws, can be used to secure a parallel against the one of the pair of jaws. Parallel keepers can be used to reduce lateral displacement upon tightening the jaws.

### CROSS REFERENCE TO RELATED APPLICATION

This application claims the benefit of U.S. Provisional Application, Ser. No. 63/560,017, filed on 1 Mar. 2024. The co-pending provisional application is hereby incorporated by reference herein in its entirety and is made a part hereof, including but not limited to those portions which specifically appear hereinafter.

### BACKGROUND OF THE INVENTION

This invention relates generally to vises and similar workpieces holders, and more particularly to components for use in/with vises to improve workpiece holding.

### SUMMARY OF THE INVENTION

A general object of the invention is to provide improved workpiece holding in vises, such as using parallels, and more preferably to workplace vise components or accessories that minimize setup time during a machining process of various parts that need to be held in the vise.

Embodiments of this invention reduce or eliminate the problem of vise parallels not being held firmly enough when the vise is open to remove the machined part and/or blow away any debris. Current products available on the market generally create a movement risk while repositioning parallel or in chips going under the parallels during the cleaning process. This can cause damage to the machined part or the cutting tool.

In some embodiments, another object is to free the space under the machined components. Embodiments of the invention provide free space below the machined components to allow an endmill's section closer to the tool holder, which helps maintain the rigidness of the tool and improves the surface finish of the machined component. In addition the space cases cleanliness and chip evacuation.

The components of this invention provide options for improved holding of workpieces and/or parallels, over current devices.

Embodiments of this invention include improvements or improved add-on components for a workpiece holder, such as including a pair of jaws. In embodiments. the improvement includes a lock element and/or retainer clip(s) connected to one of the pair of jaws.

The lock element can be a work piece lock element that is moveable and lockable along a top surface of one of the pair of jaws. The work piece lock element can be locked in place by a positive lock, such as including a threaded element, a rounded or spherical element, and/or a spring loaded ball. As used herein, “positive lock” generally refers to securing components through direct mechanical engagement, preventing relative movement without relying solely on friction, pressure, or torque retention. In embodiments, a row of detents is disposed in one of the jaws, and each of the detents is configured to receive the positive lock. For example, in embodiments the threaded element can push against a ball, or lock the spring loaded ball in a detent.

In embodiments, the improvement additionally or alternative includes an adjustable side extension for laterally securing workpieces in the holder. The side extension can be adjusted longitudinally and/or laterally.

In embodiments, the improvement additionally or alternative includes a pair of clips, each attached to a side of one of the pair of jaws and together configured to secure a parallel against the one of the pair of jaws.

In embodiments, the improvement additionally or alternative includes a parallel keeper including a first keeper element including a female detent and a second keeper element including a male end that fits within the female detent to reduce lateral displacement upon tightening the jaws.

Other objects and advantages will be apparent to those skilled in the art from the following detailed description taken in conjunction with the appended claims and drawings.

### BRIEF DESCRIPTION OF THE DRAWINGS

FIGS. 1-6 show an exemplary vise including several components of this invention in combination.

FIGS. 7-16 show a lock according to embodiments of this invention. FIG. 12 is a sectional view along A-A in FIG. 10. FIG. 13 is a sectional view along B-B in FIG. 10. FIG. 14 is a sectional view along C-C in FIG. 10. FIG. 15 is a sectional view along E-E in FIG. 11. FIG. 16 is an enlarged view of (F) in FIG. 15.

FIG. 17 shows a lock according to embodiments of this invention.

FIGS. 18-21 show a lock according to embodiments of this invention.

FIGS. 22 and 23 show opposing adjustable side extensions according to embodiments of this invention.

FIGS. 24-25 show parallel clips and vise parallels according to embodiments of this invention.

FIGS. 26-30 show a parallel holder or parallel keeper disposed between parallels, and in combination with the parallel clips, according to embodiments of this invention.

FIGS. 31-33 show a parallel keeper used alone, according to embodiments of this invention.

### DETAILED DESCRIPTION OF THE INVENTION

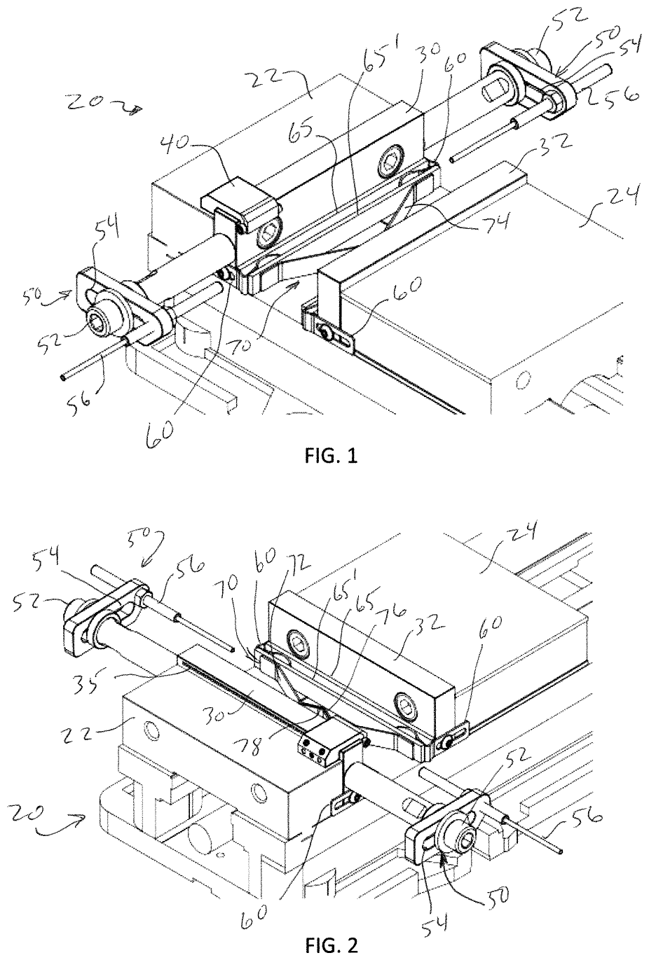

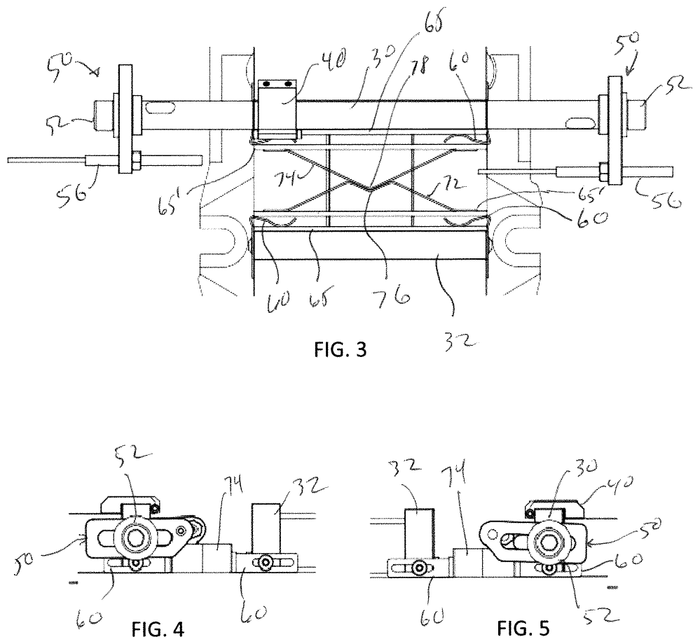

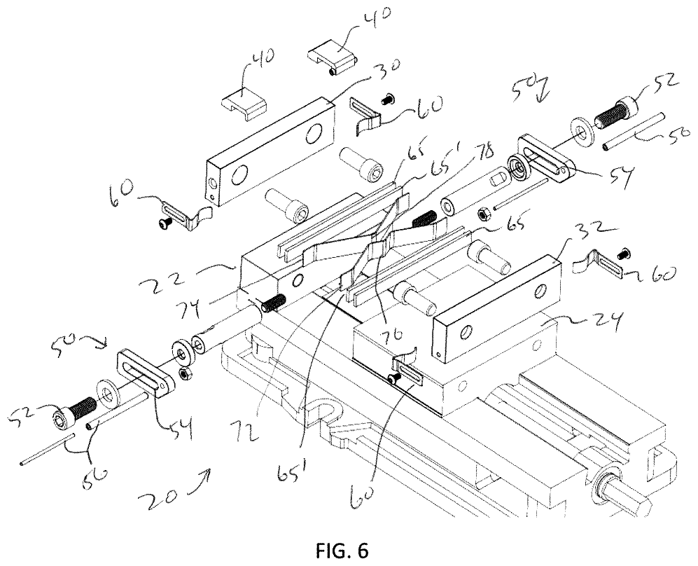

FIGS. 1-6 show an exemplary vise 20, including a stationary jaw 22 and a movable jaw 24, and further including several components of this invention in combination. The components can be used separately as disclosed in later figures, or in various combinations. The components can be integrally connected to the vise, such as at manufacturing, but are desirably separate components that can be applied to various vise designs, past, present, and future.

FIGS. 1-6 show a pair of setup jaw components 30 and 32, or simply setup jaws, which can be integral to the vise or attached to existing vise jaws 22 and/or 24. The setup jaws 30 and 32 include connection points for one or more of the vise components of this invention.

In embodiments of this invention, at least one workpiece lock element is attached to a top surface of at least one of the setup jaws. As shown in FIGS. 1-6, positive lock 40 is attached to setup jaw 30. Positive lock 40 is moveable along the top surface of setup jaw 30, and lockable in a desired place along the top surface. The positive lock 40 preferably includes one or more locking elements, such a threaded element that tightens against the setup jaw 30. As shown in FIG. 2, the setup jaw 30 preferably includes a row of detents 35 along a back surface to receive a locking element of the positive lock 40.

In embodiments of this invention, at least one workpiece side extension element is attached to a side or end surface of at least one of the jaws. As shown in FIGS. 1-6, an adjustable side extension 50 is attached, such as by threaded connection, to sides of the setup jaw 30. The side extension 50 is adjustable in the longitudinal direction of the vise 20 via fastener 52 in elongated opening 54. Adjustable lock extensions 56 contact the sides of the workpiece to laterally secure the workpiece. In the illustrated embodiment, the lock extensions 56 have two differently sized ends. The extensions 56 are reversible and have a narrow end that can be used for securing small/thin parts (e.g., less than 0.25″ wide), and a wider end for larger parts.

In embodiments of this invention, a parallel clip 60 is attached to each of the opposing sides of at least one of the setup jaws 30, 32. As shown, a parallel clip 60 is attached to both opposing sides of both setup (fixed) jaw 30, and movable jaw 32, by a threaded fastener. The parallel clips 60 hold any added vise parallels 65 to the setup jaws 30, 32 by a spring force.

In embodiments of this invention, a parallel keeper 70 is disposed between the parallels 65. The parallel keeper 70 is formed of a first keeper element 72 including a ‘female’ detent 76 to receive a ‘male’ end 78 of a second keeper element 74. The two keeper elements 72, 74 fit together to avoid lateral displacement upon tightening the vise jaws 30, 32. The parallel keepers 72 and 74 can be used by alone to hold the parallels in place, or in combination with parallel keepers 60 if an application requires additional parallel holding.

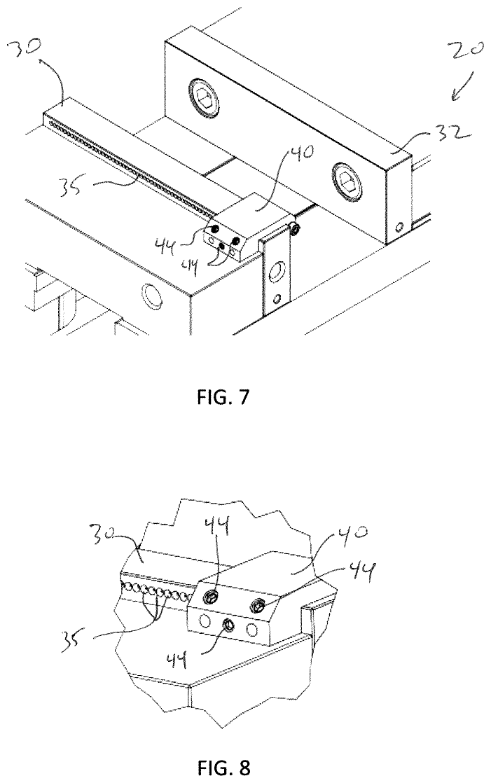

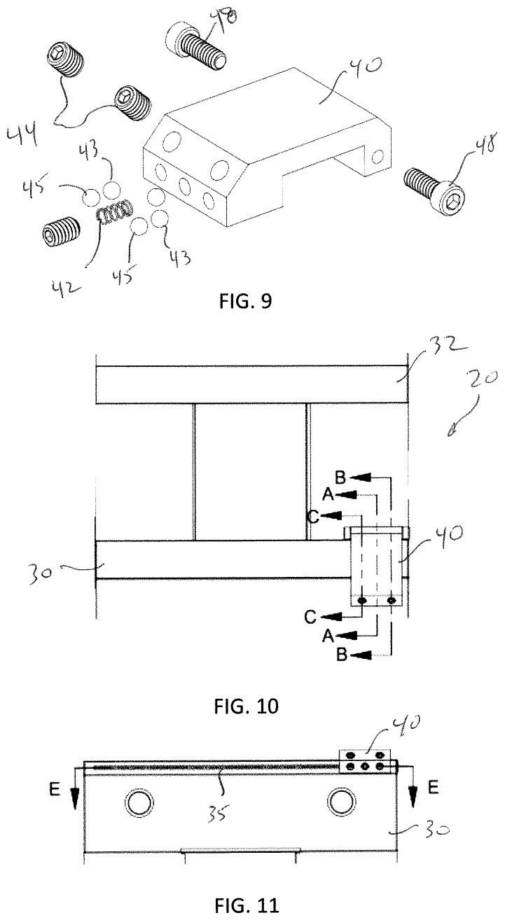

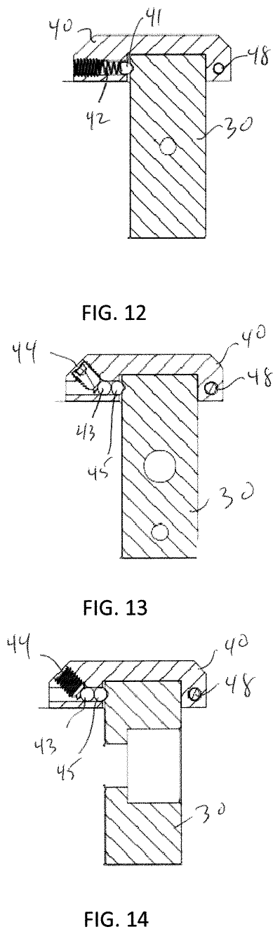

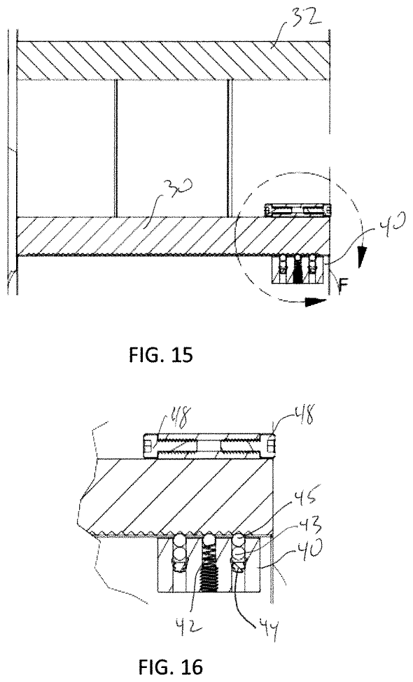

FIGS. 7-16 illustrate positive lock 40 according to one embodiment of this invention. FIG. 7 shows the positive lock 40 attached to a top surface of setup jaw 30. Positive lock 40 is moveable along the top surface of setup jaw 30, and lockable in a desired place along the top surface. The setup jaw 30 includes a row of detents 35 along a back surface to receive a locking element of the positive lock 40. In this embodiment, the positive lock 40 includes threaded elements that tighten against spherical elements that fit into the detents 35. Referring to FIG. 9, the positive lock 40 includes a central, spring loaded ball 41 that moves back and forth into and out of detents 35 against spring 42 as the positive lock 40 is moved along the setup jaw 30. This assists in correct placement of the positive lock 40. When the desired position is obtained, additional locking ball elements 43 are locked into corresponding, adjacent detents 35 by tightening their corresponding threaded elements 44. In the illustrated embodiments, the threaded elements 44 are disposed at an angle, and tighten against an intermediary ball 45, which pushes against ball 43 to secure it in a corresponding detent 35.

FIGS. 7-16 further illustrate a pair of, preferably lateral threaded, contact elements 48, which extend from the side of the positive lock 40 to contact the workpiece or other item between the vise.

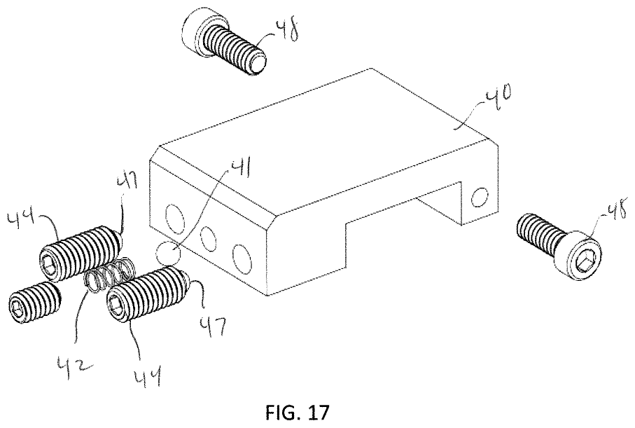

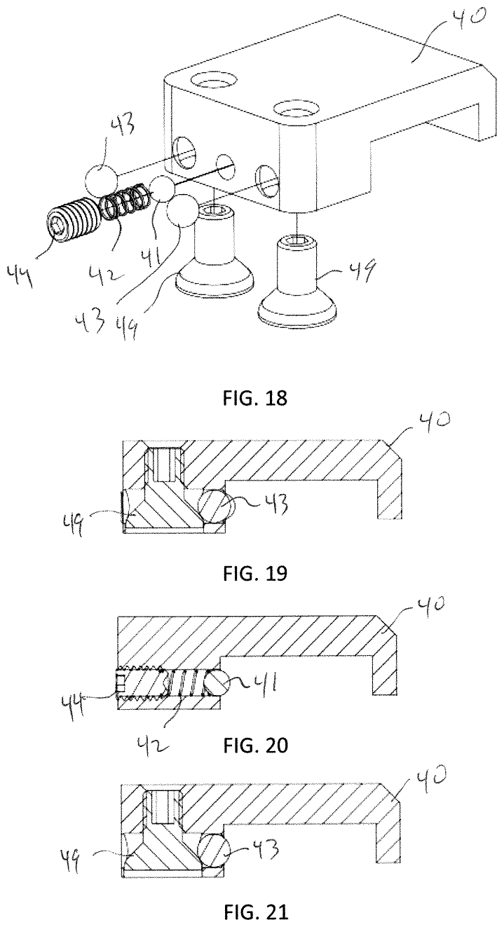

FIG. 17 shows an alternative embodiments, where the threaded elements 44 are designed with an end 47 to fit directly into a detent 35. FIGS. 18-21 show another embodiment, where one or more conical elements 49 are tightened from a top or bottom to push the locking ball 43 into the detent 35.

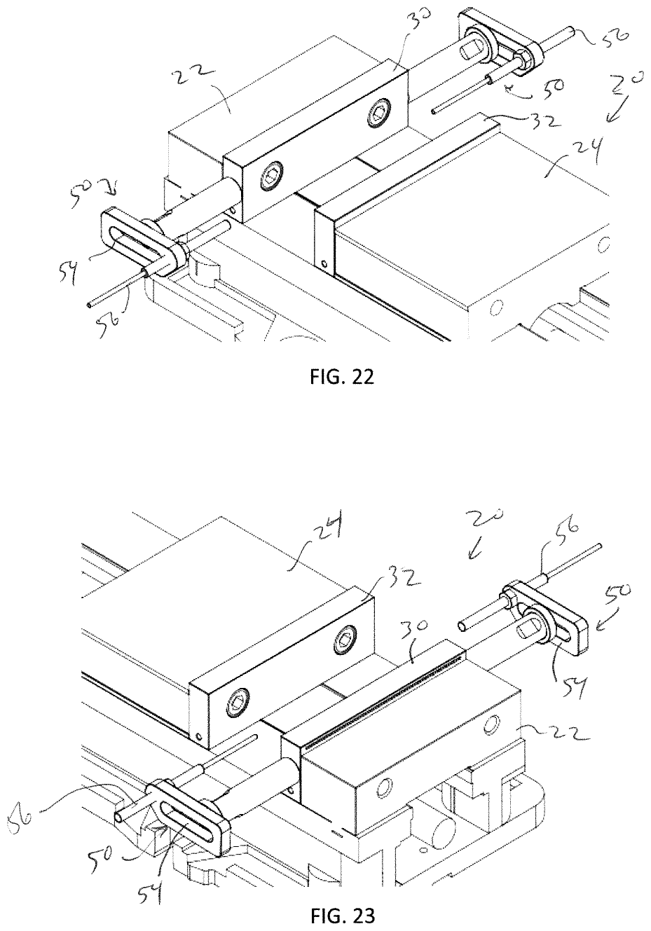

FIGS. 22 and 23 show opposing adjustable side extensions 50 attached to sides of the setup jaw 30.

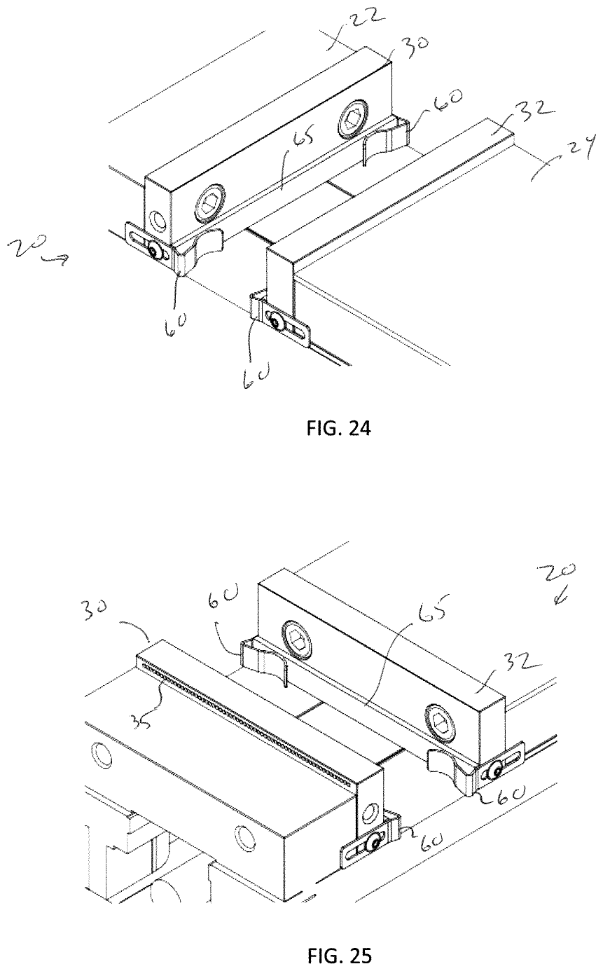

FIGS. 24-25 show parallel clips 60 attached to each of the opposing sides of the setup jaws 30, 32, and holding vise parallels 65 to the setup jaws 30, 32 by a spring force.

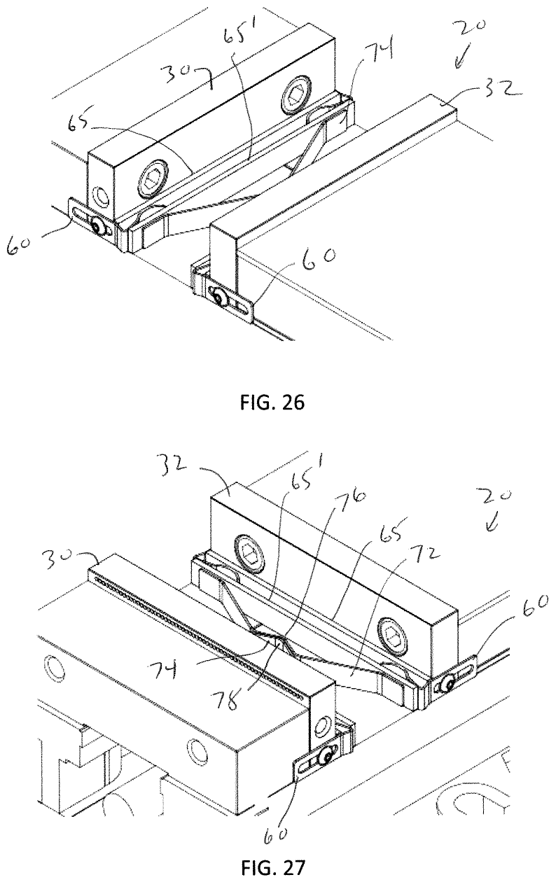

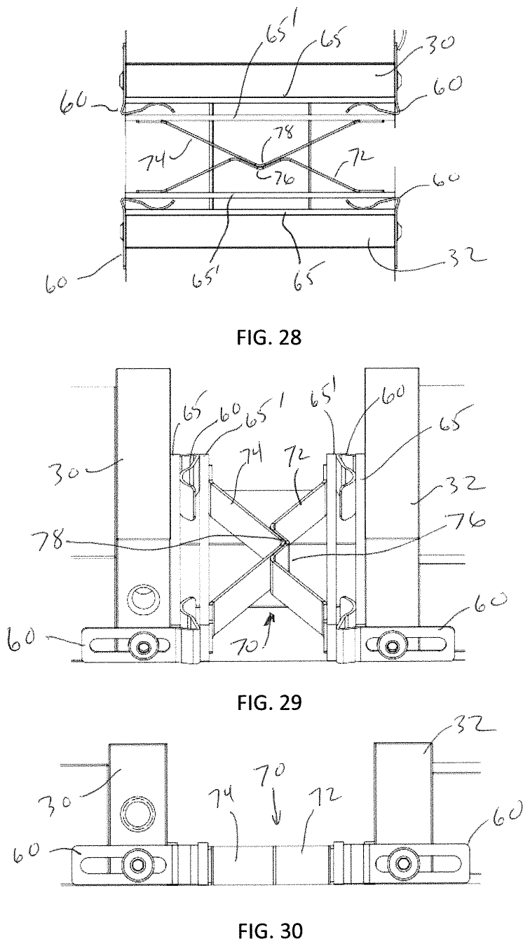

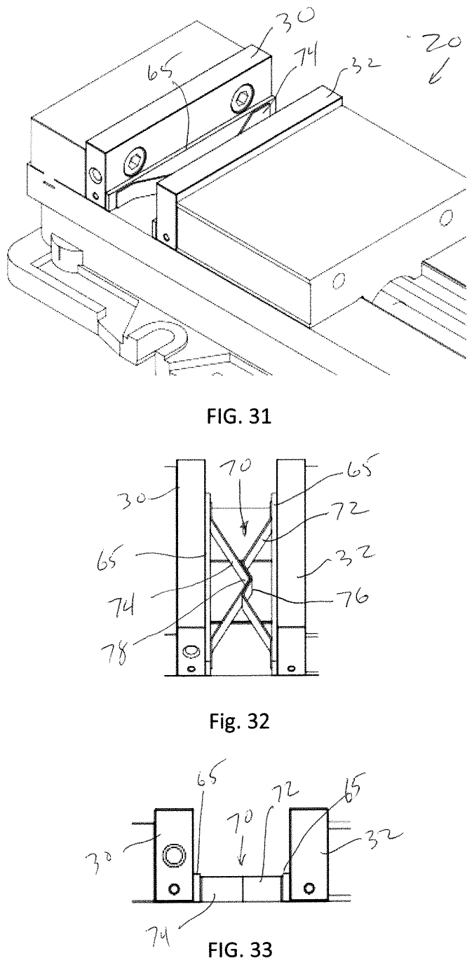

FIGS. 26-30 show a parallel holder or parallel keeper 70 disposed between the parallels, used in combination with the parallel clips 60. FIGS. 31-33 show a parallel keeper 70 used alone. The parallel keeper 70 is shown as supported on a second pair of parallels 65′ disposed on an outer side of the parallel clips. The parallel keeper 70 is formed of a first keeper element 72 including a ‘female’ detent 76 to receive a ‘male’ end 78 of a second keeper element 74. The two keeper elements 72, 74 fit together to avoid lateral displacement upon tightening the vise jaws 30, 32. The parallel keeper 70 can be produced in different height sizes, and generally one will want to use a size smaller than the parallel itself.

The invention illustratively disclosed herein suitably may be practiced in the absence of any element, part, step, component, or ingredient which is not specifically disclosed herein.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

What is claimed is:

1. An improvement for a workpiece holder, the holder including a pair of jaws, the improvement comprising a lock component connected to one of the pair of jaws.

2. The improvement of claim 1, wherein the lock component is moveable and lockable along a top surface of one of the pair of jaws.

3. The improvement of claim 2, wherein the lock component comprises a threaded element, a ball element, and/or a spring loaded ball.

4. The improvement of claim 3, further comprising a row of detents disposed in the one of the pair of jaws, wherein each of the detents is configured to receive the threaded element, the ball element, and/or the spring loaded ball.

5. The improvement of claim 1, further comprising an adjustable side extension for laterally securing workpieces in the holder.

6. The improvement of claim 1, wherein the lock component comprises a pair of clips, each attached to a side of one of the pair of jaws and together configured to secure a parallel against the one of the pair of jaws.

7. The improvement of claim 1, further comprising a parallel keeper including a first keeper element including a female detent and a second keeper element including a male end that fits within the female detent to reduce lateral displacement upon tightening the jaws.
